(19) United States
(12) Patent Application Publication
(10) Pub. No.: US 2022/0111841 A1
(43) Pub. Date: Apr. 14, 2022

(54) VEHICLE CONTROLLER AND METHOD FOR CONTROLLING VEHICLE

(71) Applicants: TOYOTA JIDOSHA KABUSHIKI KAISHA, Toyota-shi (JP); DENSO CORPORATION, Kariya-city (JP)

(72) Inventors: Ryusuke KURODA, Tokyo-to (JP); Takuya FUJIKI, Tokyo-to (JP)

(21) Appl. No.: 17/498,831

(22) Filed: Oct. 12, 2021

(30) Foreign Application Priority Data
Oct. 14, 2020 (JP) 2020-173579

(51) Int. Cl. B60W 30/16; B60W 40/04; B60W 40/072; B60W 40/076; B60W 60/00; G06K 9/00

(52) U.S. Cl. CPC B60W 30/162; B60W 40/04; B60W 40/072; B60W 40/076; B60W 60/0059; B60W 2556/40; G06K 9/00825; B60W 2552/15; B60W 2552/30; B60W 2554/406; B60W 2554/802; B60W 60/0053

(57) ABSTRACT

A vehicle controller for automated driving control of a vehicle in traffic congestion includes a processor configured to determine whether the situation around the vehicle is a detection-enabled situation in which another vehicle traveling on a road within a predetermined distance of the vehicle in a travel direction of the vehicle is detectable by a sensor for detecting the situation around the vehicle, the sensor being mounted on the vehicle, and determine whether congestion is relieved around the vehicle, based on motion of the other vehicle detected based on a sensor signal obtained by the sensor, when the situation around the vehicle is the detection-enabled situation.

### FIELD

The present invention relates to a vehicle controller and a method for automated driving control of a vehicle.

### BACKGROUND

Techniques have been researched for determining whether traffic is congested around a vehicle and controlling the vehicle when traffic is congested therearound (see, Japanese Unexamined Patent Publications Nos. 2015-108955 and 2009-511357).

In the technique described in Japanese Unexamined Patent Publication No. 2015-108955, a drive support device determines that a road is congested, when received road traffic information is congestion information and speed information of a host vehicle indicates a speed not greater than a predetermined speed. Additionally, the drive support device determines that congestion of a road is relieved when a distance from a leading vehicle is not detected after determining that the road is congested.

In the technique described in Japanese Unexamined Patent Publication No. 2009-511357, a distance and speed controller for a vehicle includes a traffic jam detection device and adjusts, to a detected traffic jam situation, control parameters for controlling the speed of the vehicle and/or the distance from a leading vehicle. The traffic jam detection device in the controller is configured to decide that there is no traffic jam when a sensor system does not locate a leading vehicle followed as a target object.

### SUMMARY

According to the above-described techniques, it is determined that traffic congestion does not exist or is relieved, when a leading vehicle traveling ahead of the host vehicle is not detected or when the distance to a leading vehicle is not measured. Thus, to correctly determine the absence or relief of congestion, it is desirable to accurately detect a leading vehicle. A failure of detection of a leading vehicle results in erroneous determination that congestion does not exist or is relieved, causing control that should be applied at relief of congestion to be executed on the host vehicle although the congestion continues.

It is an object of the present invention to provide a vehicle controller that can prevent erroneous determination that congestion is relieved.

According to an embodiment, a vehicle controller for automated driving control of a vehicle in traffic congestion is provided. The vehicle controller includes a processor configured to determine whether the situation around the vehicle is a detection-enabled situation in which another vehicle traveling on a road within a predetermined distance of the vehicle in a travel direction of the vehicle is detectable by a sensor for detecting the situation around the vehicle, the sensor being mounted on the vehicle, and determine whether congestion is relieved around the vehicle, based on motion of the other vehicle detected based on a sensor signal obtained by the sensor, when the situation around the vehicle is the detection-enabled situation.

The processor of the vehicle controller preferably is further configured to determine whether there is a blind area where the other vehicle is undetectable within the predetermined distance, based on map information stored in a memory or an image obtained by the sensor taking a picture in the travel direction of the vehicle, and the processor determines that the situation is not a detection-enabled situation, when the blind area exists.

In this case, the processor preferably determines that the blind area exists, when it is detected that the road in the travel direction of the vehicle has a curve within the predetermined distance and that there is a shielding object inside the curve of the road, based on the map information and the current position of the vehicle or on the image, and the curvature of the curve of the road is not less than a predetermined threshold.

Alternatively, the processor preferably determines that the blind area exists, when it is detected that the current position of the vehicle is on an upward slope and that the top of the upward slope is within the predetermined distance, based on the map information and the current position of the vehicle.

According to another embodiment, a method for automated driving control of a vehicle in traffic congestion is provided. The method includes determining whether the situation around the vehicle is a detection-enabled situation in which another vehicle traveling on a road within a predetermined distance of the vehicle in a travel direction of the vehicle is detectable by a sensor for detecting the situation around the vehicle, the sensor being mounted on the vehicle; and determining whether congestion is relieved around the vehicle, based on motion of the other vehicle detected based on a sensor signal obtained by the sensor, when the situation around the vehicle is the detection-enabled situation.

The vehicle controller has an advantageous effect of being able to prevent erroneous determination that congestion is relieved.

### BRIEF DESCRIPTION OF DRAWINGS

FIG. 1 schematically illustrates the configuration of a vehicle control system including a vehicle controller.

FIG. 2 illustrates the hardware configuration of an electronic control unit, which is an embodiment of the vehicle controller.

FIG. 3 is a functional block diagram of a processor of the electronic control unit, related to a vehicle control process.

FIG. 4A is an explanatory diagram illustrating an example of a detection-disabled situation.

FIG. 4B is an explanatory diagram illustrating an example of a detection-enabled situation.

FIG. 5 is an explanatory diagram illustrating another example of a detection-disabled situation.

FIG. 6 is an operation flowchart of the vehicle control process related to switching from manual driving mode to automated driving mode.

FIG. 7 is an operation flowchart of the vehicle control process related to switching from automated driving mode to manual driving mode.

### DESCRIPTION OF EMBODIMENTS

Hereinafter, a vehicle controller and a method for controlling a vehicle executed by the vehicle controller will be described with reference to the drawings. The vehicle controller executes automated driving control of a vehicle in traffic congestion. For this purpose, the vehicle controller determines whether traffic is congested around the vehicle, based on, for example, motion of another vehicle detected based on a sensor signal obtained by a sensor mounted on the vehicle. Upon relief of congestion around the vehicle, the vehicle controller switches the applied driving mode from automated driving mode, in which the vehicle controller controls travel of the vehicle, to manual driving mode, in which the driver controls travel of the vehicle. To prevent erroneous determination that congestion is relieved, the vehicle controller determines whether the situation around the vehicle is a detection-enabled situation in which another vehicle traveling on a road within a predetermined distance of the vehicle in a travel direction of the vehicle is detectable by the sensor, which detects the situation around the vehicle and is mounted on the vehicle. The vehicle controller determines whether congestion is relieved, only when the situation is a detection-enabled situation.

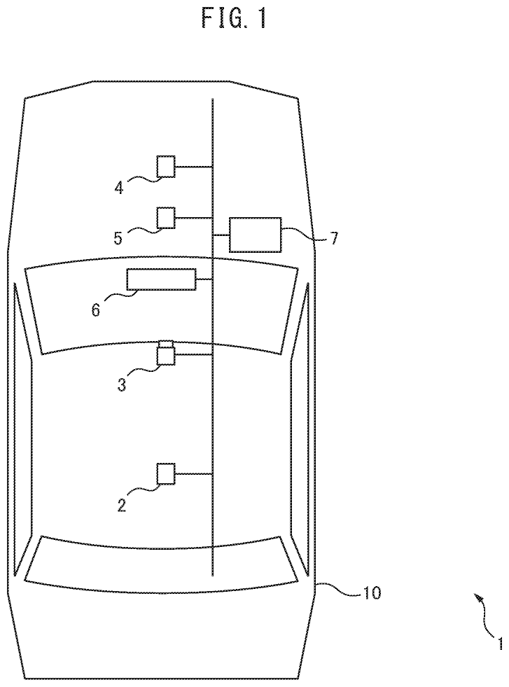

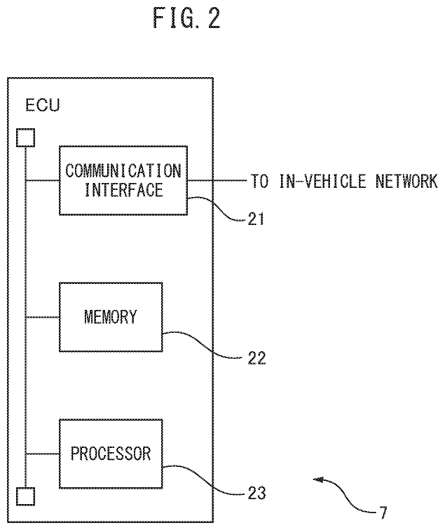

FIG. 1 schematically illustrates the configuration of a vehicle control system including a vehicle controller. FIG. 2 illustrates the hardware configuration of an electronic control unit, which is an embodiment of the vehicle controller. In the present embodiment, a vehicle control system 1, which is mounted on a host vehicle 10 and controls the vehicle 10, includes a GPS receiver 2, a camera 3, a wireless communication device 4, a storage device 5, a user interface 6, and an electronic control unit (ECU) 7, which is an example of the vehicle controller. The GPS receiver 2, the camera 3, the wireless communication device 4, the storage device 5, and the user interface 6 are connected to the ECU 7 so that they can communicate via an in-vehicle network conforming to a standard, such as a controller area network. The vehicle control system 1 may further include a distance sensor (not illustrated), such as LiDAR or radar, which measures the distance from the vehicle 10 to an object in an area around the vehicle 10. Such a distance sensor is an example of a sensor for detecting the situation around the vehicle 10. The vehicle control system 1 may further include a navigation device (not illustrated) for searching for a planned travel route to a destination.

The GPS receiver 2 receives a GPS signal from a GPS satellite at predetermined intervals, and determines the position of the vehicle 10, based on the received GPS signal. The GPS receiver 2 outputs positioning information indicating the result of determination of the position of the vehicle 10 based on the GPS signal to the ECU 7 via the in-vehicle network at predetermined intervals. The vehicle 10 may include a receiver conforming to a satellite positioning system other than the GPS receiver 2. In this case, the receiver determines the position of the vehicle 10.

The camera 3, which is an example of a sensor for detecting the situation around the vehicle 10, includes a two-dimensional detector constructed from an array of optoelectronic transducers, such as CCD or C-MOS, having sensitivity to visible light and a focusing optical system for focusing an image of a target region on the two-dimensional detector. The camera 3 is mounted, for example, in the interior of the vehicle 10 so as to be oriented, for example, to the front of the vehicle 10. The camera 3 captures a region in front of the vehicle 10 every predetermined capturing period (e.g., 1/30 to 1/10 seconds), and generates images in which the region is captured. The images obtained by the camera 3, each of which is an example of the sensor signal, may be color or gray images. The vehicle 10 may include multiple cameras taking pictures in different orientations or having different focal lengths.

Every time it generates an image, the camera 3 outputs the generated image to the ECU 7 via the in-vehicle network.

The wireless communication device 4 communicates with a wireless base station by wireless in conformity with a predetermined standard of mobile communications. The wireless communication device 4 receives, from another device via the wireless base station, traffic information indicating the traffic situation of the road being traveled by the vehicle 10 or the area therearound, e.g., information provided by the Vehicle Information and Communication System (VICS [registered trademark]), and outputs the traffic information to the ECU 7 via the in-vehicle network. The traffic information includes, for example, information on the presence or absence of road construction, an accident, or traffic restrictions, and the places and times of day at which the road construction is carried out, the accident occurred, or the traffic restrictions are imposed. The wireless communication device 4 may receive a high-precision map of a predetermined region around the current position of the vehicle 10 from a map server via the wireless base station, and output the received map to the storage device 5. The high-precision map is used for automated driving control.

The storage device 5, which is an example of a storage unit, includes, for example, a hard disk drive, a nonvolatile semiconductor memory, or an optical recording medium and an access device therefor. The storage device 5 stores a high-precision map, which is an example of map information. The high-precision map includes, for example, information indicating road markings, such as lane dividing lines or stop lines, signposts, and buildings or structures around roads (e.g., noise-blocking walls) for each road included in a predetermined region represented in the map.

The storage device 5 may further include a processor for executing, for example, a process to update the high-precision map and a process related to a request from the ECU 7 to read out the high-precision map. For example, every time the vehicle 10 moves a predetermined distance, the storage device 5 may transmit the current position of the vehicle 10 and a request to acquire the high-precision map to the map server via the wireless communication device 4, and receive a high-precision map of a predetermined region around the current position of the vehicle 10 from the map server via the wireless communication device 4. When receiving a request from the ECU 7 to read out the high-precision map, the storage device 5 cuts out that portion of the high-precision map stored therein which includes the current position of the vehicle 10 and which represents a region smaller than the predetermined region, and outputs the cut portion to the ECU 7 via the in-vehicle network.

The user interface 6, which is an example of a notifying unit, includes, for example, a display, such as a liquid crystal display, or a touch screen display. The user interface 6 is mounted in the interior of the vehicle 10, e.g., near an instrument panel, so as to face the driver. The user interface 6 displays various types of information received from the ECU 7 via the in-vehicle network to notify the driver of the information. The user interface 6 may further include a speaker mounted in the interior of the vehicle. In this case, the user interface 6 outputs, in the form of a voice signal, various types of information received from the ECU 7 via the in-vehicle network to notify the driver of the information.

The information notified by the user interface 6 to the driver includes, for example, notification information that the driving mode applied to the vehicle 10 will change (e.g., notification information on switching from automated driving mode to manual driving mode or vice versa) or notification information that the driver is required to hold the steering wheel or look ahead.

The ECU 7 determines whether traffic is congested around the vehicle 10. When traffic is congested around the vehicle 10, the ECU 7 sets the driving mode applied to control of the vehicle 10 to automated driving mode and controls travel of the vehicle 10.

As illustrated in FIG. 2, the ECU 7 includes a communication interface 21, a memory 22, and a processor 23. The communication interface 21, the memory 22, and the processor 23 may be separate circuits or a single integrated circuit.

The communication interface 21 includes an interface circuit for connecting the ECU 7 to the in-vehicle network. Every time it receives positioning information from the GPS receiver 2, the communication interface 21 passes the positioning information to the processor 23. Every time it receives an image from the camera 3, the communication interface 21 passes the received image to the processor 23. Additionally, the communication interface 21 passes the high-precision map read from the storage device 5 to the processor 23. When receiving notification information from the processor 23, the communication interface 21 outputs the notification information to the user interface 6.

The memory 22, which is another example of a storage unit, includes, for example, volatile and nonvolatile semiconductor memories. The memory 22 stores various types of data used in a vehicle control process executed by the processor 23 of the ECU 7. For example, the memory 22 stores images of surroundings of the vehicle 10, the result of determination of the position of the vehicle, the high-precision map, internal parameters of the camera 3, such as parameters indicating its focal length, angle of view, orientation, and mounted position, and a set of parameters for specifying an object-detecting classifier used for detecting, for example, a vehicle traveling in an area around the vehicle 10. Additionally, the memory 22 temporarily stores various types of data generated during the vehicle control process.

The processor 23 includes one or more central processing units (CPUs) and a peripheral circuit thereof The processor 23 may further include another operating circuit, such as a logic-arithmetic unit, an arithmetic unit, or a graphics processing unit. The processor 23 executes the vehicle control process for the vehicle 10.

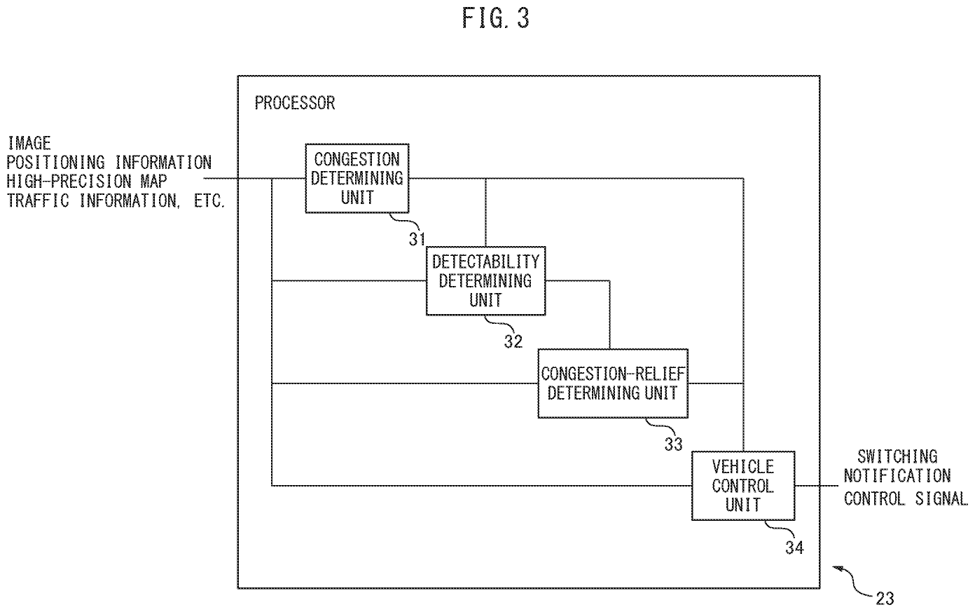

FIG. 3 is a functional block diagram of the processor 23, related to the vehicle control process. The processor 23 includes a congestion determining unit 31, a detectability determining unit 32, a congestion-relief determining unit 33, and a vehicle control unit 34. These units included in the processor 23 are, for example, functional modules implemented by a computer program executed on the processor 23, or may be dedicated operating circuits provided in the processor 23.

The congestion determining unit 31 determines, at predetermined intervals (e.g., 0.1 to several seconds), whether congestion has occurred around the vehicle 10, in the case that congestion did not occur around the vehicle 10 until the previous predetermined period.

For example, the congestion determining unit 31 determines whether congestion has occurred around the vehicle 10, based on the speed of the vehicle 10 measured by a vehicle speed sensor (not illustrated) mounted on the vehicle 10. In this case, the congestion determining unit 31 determines that congestion has occurred around the vehicle 10, for example, when a state in which the measurement value of the speed of the vehicle 10 acquired from the vehicle speed sensor via the communication interface 21 is not greater than a first speed threshold (e.g., 20 km/h) continues for a first period (e.g., 5 seconds) or more. Alternatively, the congestion determining unit 31 may determine that congestion has occurred around the vehicle 10, when a state in which the measurement value of the speed of the vehicle 10 is not greater than a second speed threshold (e.g., 10 km/h) continues for a second period (e.g., 3 seconds) or more. The second speed threshold is less than the first speed threshold, and the second period is shorter than the first period. Alternatively, the congestion determining unit 31 may determine that congestion has occurred around the vehicle 10, when changes in the measurement value of the speed of the vehicle 10 in a preceding first predetermined period (e.g., 3 seconds) are within a predetermined range of changes in speed (e.g., 1 m/s). In this case, it may determine that congestion has occurred around the vehicle 10, only when the average of the speed of the vehicle 10 in the first predetermined period is not greater than a predetermined speed. The predetermined speed may be set, for example, at a speed obtained by subtracting a predetermined offset (e.g., 20 km/h to 40 km/h) from the legally permitted speed or the regulation speed of the road being traveled by the vehicle 10. In this case, the congestion determining unit 31 may refer to, for example, the high-precision map and the current position of the vehicle 10 indicated by positioning information received from the GPS receiver 2 to identify the legally permitted speed or the regulation speed of the road being traveled by the vehicle 10. The congestion determining unit 31 may compare a feature represented in an image obtained by the camera 3 with the high-precision map to estimate the current position and orientation of the vehicle 10. For example, the congestion determining unit 31 makes an assumption about the position and orientation of the vehicle 10, and projects features on the road (e.g., road markings, such as lane dividing lines or stop lines) detected from an image obtained from the camera 3 onto the high-precision map by referring to internal parameters of the camera 3, or projects features on the road around the vehicle 10 in the high-precision map onto the image. Then, the congestion determining unit 31 may estimate the current position and orientation of the vehicle 10 to be the position and orientation of the vehicle 10 for the case that the features on the road detected from the image best match with those on the road represented in the high-precision map. For example, the congestion determining unit 31 may input an image into a classifier to detect features from the image. As such a classifier, the congestion determining unit 31 may uses, for example, a deep neural network (DNN) having a convolutional neural network (CNN) architecture, such as Single Shot MultiBox Detector (SSD) or Faster R-CNN. Such a classifier is trained in advance to detect objects around the vehicle 10 (e.g., other vehicles, road markings, such as lane dividing lines, and signposts) from an image.

The congestion determining unit 31 may determine that congestion has occurred around the vehicle 10, when the vehicle 10 has stopped for a second predetermined period (e.g., 1 second) or more.

Alternatively, the congestion determining unit 31 may determine whether congestion has occurred around the vehicle 10, based on motion of a vehicle traveling in an area around the vehicle 10. For example, every time the ECU 7 acquires an image from the camera 3, the congestion determining unit 31 inputs the image into a classifier to detect a vehicle traveling in an area around the vehicle 10. As the classifier, the congestion determining unit 31 may use a DNN having a CNN architecture, as described above.

The congestion determining unit 31 executes a predetermined tracking process, such as a tracking process using optical flow, on vehicles detected from each of time-series images acquired from the camera 3 to track these vehicles. The congestion determining unit 31 then executes viewpoint transformation on each image, using internal parameters of the camera 3, to transform the image into an aerial image, thereby calculating the positions of the tracked vehicles relative to the vehicle 10 at the time of acquisition of each image. The bottom of an object region representing a vehicle is assumed to correspond to the position where the vehicle is in contact with the road surface. Thus, the congestion determining unit 31 may estimate the distance from the vehicle 10 to another vehicle at the time of acquisition of each image, based on the direction from the camera 3 to the position corresponding to the bottom of the object region representing the latter vehicle in each image and on the height of the camera 3 from the road surface, which is one of the internal parameters of the camera 3. The congestion determining unit 31 may use an estimated value of the distance from the vehicle 10 to a tracked vehicle at the time of acquisition of each image to calculate the position of the tracked vehicle relative to the vehicle 10.

Of the tracked vehicles, the congestion determining unit 31 selects a leading vehicle traveling ahead of the vehicle 10. When there are multiple leading vehicles, the congestion determining unit 31 may select the one closest to the vehicle 10 from these vehicles. The congestion determining unit 31 then calculates changes in the speed of the selected leading vehicle relative to the vehicle 10 and changes in the distance between these vehicles in a preceding predetermined period (e.g., 3 to 5 seconds), based on changes in the relative position of the leading vehicle in the preceding predetermined period.

Alternatively, in the case that the vehicle 10 includes a distance sensor, such as LiDAR or radar, the congestion determining unit 31 may determine that there is a leading vehicle, when the measurement value of the distance obtained by the distance sensor in a predetermined range of angles ahead of the vehicle 10 (e.g., a range of angles of ±30° parallel to the road surface centered at the travel direction of the vehicle 10) is not greater than a predetermined value. Then, the congestion determining unit 31 may calculate changes in the speed of the leading vehicle relative to the vehicle 10 and changes in the distance between these vehicles in the preceding predetermined period, based on changes in the measurement value of the distance obtained by the distance sensor in the preceding predetermined period.

The congestion determining unit 31 determines that congestion has occurred around the vehicle 10, when the absolute value of the speed of the leading vehicle relative to the vehicle 10 is not greater than a predetermined relative-speed threshold (e.g., 1 m/s) and the distance between the vehicle 10 and the leading vehicle is within a predetermined distance range (e.g., not less than 3 m nor greater than 25 m) over the preceding predetermined period.

Alternatively, for every tracked vehicle, the congestion determining unit 31 may calculate changes in the speed of the tracked vehicle relative to the vehicle 10 and changes in the distance between these vehicles in the preceding predetermined period. Then, the congestion determining unit 31 may determine that congestion has occurred around the vehicle 10, when the speed of every tracked vehicle relative to the vehicle 10 is not greater than a predetermined relative-speed threshold (e.g., 3 m/s) over the preceding predetermined period. Of the tracked vehicles, the congestion determining unit 31 may use only vehicles traveling on a lane adjoining the travel lane of the vehicle 10 (hereafter simply an “adjoining lane”) for determination of congestion. In this case, for example, the congestion determining unit 31 may determine that tracked vehicles on the side opposite to the vehicle 10 with respect to a lane dividing line detected by a classifier are vehicles traveling on an adjoining lane. Alternatively, the congestion determining unit 31 may determine that tracked vehicles separated from a line along the travel direction of the vehicle 10 more than a lane width are vehicles traveling on an adjoining lane.

Alternatively, the congestion determining unit 31 may determine that congestion has occurred around the vehicle 10, when traffic information received via the wireless communication device 4 indicates occurrence of congestion in the road being traveled by the vehicle 10. In this case, the congestion determining unit 31 may refer to the current position of the vehicle 10 and the high-precision map to identify the road being traveled by the vehicle 10.

Alternatively, the congestion determining unit 31 may determine that congestion has occurred around the vehicle 10, only when it is determined so by two or more of the above-described techniques for determination of congestion.

When it is determined that congestion has occurred around the vehicle 10, the congestion determining unit 31 notifies the result of determination to the detectability determining unit 32 and the vehicle control unit 34.

The detectability determining unit 32 determines whether the situation around the vehicle 10 is a detection-enabled situation in which another vehicle traveling on a road within a predetermined distance of the vehicle 10 in the travel direction of the vehicle 10 is detectable by the camera 3 or the distance sensor mounted on the vehicle 10, at predetermined intervals while traffic is congested around the vehicle 10. The situation in which another vehicle traveling on a road within the predetermined distance of the vehicle 10 in the travel direction of the vehicle 10 is undetectable by the camera 3 or the distance sensor mounted on the vehicle 10 will be referred to as a detection-disabled situation, below.

If it determines whether congestion is relieved when the situation around the vehicle 10 is a detection-disabled situation, the ECU 7 cannot detect a vehicle traveling ahead of the host vehicle and thus may erroneously determine that congestion is relieved even though the congestion continues. In this case, even if once it is erroneously determined that congestion is relieved, thereafter it will probably be determined that congestion has occurred again. This will cause a request for handover of operation of the vehicle 10 to the driver or frequent handover of operation of the vehicle 10 between the driver and the ECU 7 although the ECU 7 is allowed to execute automated driving control of the vehicle 10. This will reduce the effect of automated driving control lightening the driver's load.

According to the present embodiment, only when it is determined by the detectability determining unit 32 that the situation around the vehicle 10 is a detection-enabled situation, the congestion-relief determining unit 33 determines whether congestion is relieved, which prevents erroneous determination that congestion is relieved even though the congestion continues. This prevents a request for handover of operation of the vehicle 10 to the driver and frequent handover of vehicle operation between the driver and the ECU 7 when the ECU 7 is allowed to execute automated driving control of the vehicle 10.

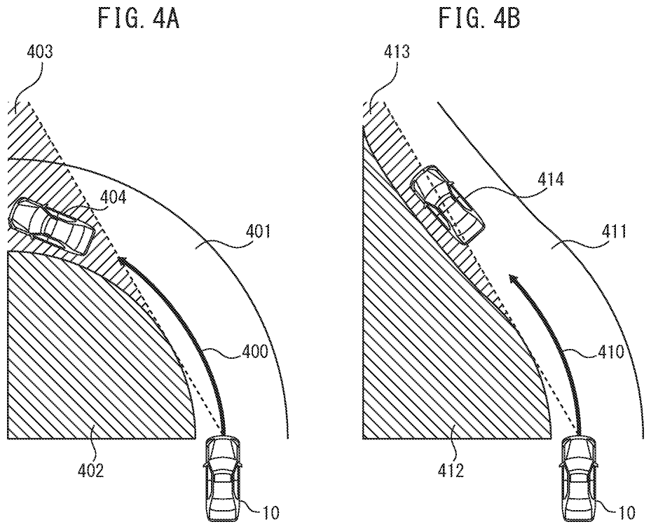

FIG. 4A is an explanatory diagram illustrating an example of a detection-disabled situation, and FIG. 4B is one illustrating an example of a detection-enabled situation. In the situation illustrated in FIG. 4A, a road 401 being traveled by the vehicle 10 has a curve in the travel direction of the vehicle 10 indicated by an arrow 400, and there is a shielding object 402 inside the curve. For this reason, the shielding object 402 makes a blind area 403 ahead of the vehicle 10 from which the camera 3 or the distance sensor mounted on the vehicle 10 can detect nothing. In this example, the blind area 403 covers all the width of the road 401 ahead of the vehicle 10 because the curvature of the curve is large. Hence a whole vehicle 404 traveling ahead of the vehicle 10 may be inside the blind area 403. When the whole vehicle 404 is inside the blind area 403 in this way, the vehicle 10 cannot detect the vehicle 404. If it determines whether congestion is relieved in the situation, the ECU 7 may erroneously determine that congestion is relieved. Thus, when the situation around the vehicle 10 is such a detection-disabled situation, the ECU 7 does not determine whether congestion is relieved.

In the situation illustrated in FIG. 4B also, a road 411 being traveled by the vehicle 10 has a curve in the travel direction of the vehicle 10 indicated by an arrow 410, and there is a shielding object 412 inside the curve. However, in the situation, a blind area 413 made by the shielding object 412 covers only part of the width of the road 411 because the curvature of the curve is small. Hence a whole vehicle 414 traveling ahead of the vehicle 10 is never included in the blind area 413. This enables the vehicle 10 to detect the vehicle 414, and thus the ECU 7 is unlikely to erroneously determine that congestion is relieved. Thus, when the situation around the vehicle 10 is such a detection-enabled situation, the ECU 7 may determine whether congestion is relieved.

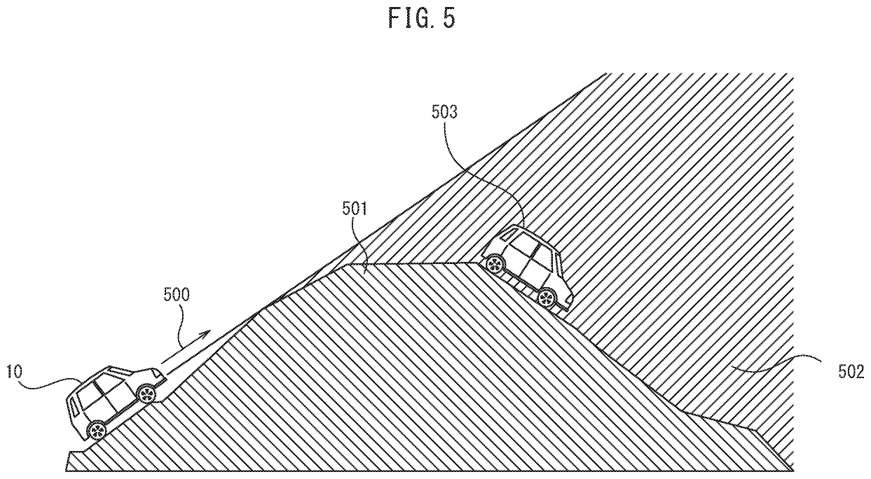

FIG. 5 is an explanatory diagram illustrating another example of a detection-disabled situation. In the situation illustrated in FIG. 5, the road being traveled by the vehicle 10 is an upward slope in the travel direction of the vehicle 10 indicated by an arrow 500, and the section beyond a location 501 is a downward slope. For this reason, the ground itself including the road is a shielding object, which makes in the section beyond the location 501 a blind area 502 from which the camera 3 or the distance sensor mounted on the vehicle 10 can detect nothing. When a vehicle 503 ahead of the vehicle 10 is traveling in the section beyond the location 501, the whole vehicle 503 is included in the blind area 502 and the vehicle 10 cannot detect the vehicle 503. Thus, when the situation around the vehicle 10 is such a detection-disabled situation, the ECU 7 does not determine whether congestion is relieved.

As described above, when there is a blind area ahead of the vehicle 10 and a whole vehicle may be included in the blind area, the vehicle 10 may not be able to detect another vehicle. Thus, when there is a blind area ahead of the vehicle 10 and another vehicle may be included in the blind area, the detectability determining unit 32 determines that the situation around the vehicle 10 is a detection-disabled situation.

More specifically, the detectability determining unit 32 refers to the current position of the vehicle 10 and the high-precision map to determine whether the road being traveled by the vehicle 10 has a curve within a predetermined distance of the vehicle 10 along the travel direction of the vehicle 10 and whether there is a shielding object inside the curve. The current position of the vehicle 10 may be, for example, the position indicated by the latest positioning information from the GPS receiver 2 or the position estimated by comparing an image obtained by the camera 3 with the high-precision map, as described in relation to the congestion determining unit 31. The predetermined distance may be, for example, the maximum distance from the vehicle 10 to another vehicle used for determining whether congestion is relieved. When the road being traveled by the vehicle 10 has a curve and there is a shielding object inside the curve, the detectability determining unit 32 determines whether the curvature of the curve is not less than a predetermined curvature threshold. When the curvature is not less than the predetermined threshold, the detectability determining unit 32 determines that the situation around the vehicle 10 is a detection-disabled situation. The predetermined threshold is set to the minimum curvature of a curve such that a blind area made by a shielding object includes a whole vehicle traveling ahead of the vehicle 10, and is prestored in the memory 22. Since the longer a curved section ahead of the vehicle 10, the larger the overlap between the blind area and the road, the curvature threshold may be preset depending on the length of a curved section and stored in the memory 22. In this case, the longer a curved section ahead of the vehicle 10, the smaller the curvature threshold may be set. The detectability determining unit 32 may determine the length of a curved section of the road being traveled by the vehicle 10 ahead of the vehicle 10 by referring to the position of the vehicle 10 and the high-precision map, read from the memory 22 the curvature threshold corresponding to the length of the curved section, and use it for comparison with the curvature of the curve.

Alternatively, the detectability determining unit 32 may determine whether the road being traveled by the vehicle 10 has a curve ahead of the vehicle 10 and whether there is a shielding object inside the curve, based on an image obtained by the camera 3. In this case, an image obtained by the camera 3 may be inputted into a classifier to detect a lane dividing line or a road demarcation line, as described in relation to the congestion determining unit 31, and the curvature of the road being traveled by the vehicle 10 may be calculated, based on the detected lane dividing line or road demarcation line. For example, the detectability determining unit 32 executes viewpoint transformation on the image, using internal parameters of the camera 3, to transform the image into an aerial image, and calculates the curvature of an arc passing through points on the lane dividing line or road demarcation line in the aerial image in accordance with, for example, the least-squares method, enabling calculation of the curvature of the road. Additionally, the detectability determining unit 32 may input an image obtained by the camera 3 into a classifier to detect a shielding object inside the curve.

Additionally, the detectability determining unit 32 refers to the current position of the vehicle 10 and the high-precision map to determine whether the current position of the vehicle 10 is on an upward slope. As described above, the current position of the vehicle 10 may be the position indicated by the latest positioning information from the GPS receiver 2 or the position estimated by comparing an image obtained by the camera 3 with the high-precision map, as described in relation to the congestion determining unit 31. When the current position of the vehicle 10 is on an upward slope, the detectability determining unit 32 refers to the current position of the vehicle 10 and the high-precision map to determine whether the top of the upward slope exists within a predetermined distance of the current position of the vehicle 10 along the travel direction of the vehicle 10. When the top of the upward slope exists within the predetermined distance of the current position of the vehicle 10, the detectability determining unit 32 determines that the situation around the vehicle 10 is a detection-disabled situation. The smaller the inclination of the upward slope at the current position of the vehicle 10, the lower the height of the blind area from the road surface beyond the top of the upward slope. Hence a whole vehicle traveling ahead of the vehicle 10 is more unlikely to be included in the blind area even if the vehicle is beyond the top of the upward slope. Thus, the detectability determining unit 32 may determine that the situation around the vehicle 10 is a detection-disabled situation, only when the inclination of the upward slope at the current position of the vehicle 10 is not less than a predetermined inclination threshold.

Additionally, when the situation around the vehicle 10 does not correspond to any of the above-described detection-disabled situations, the detectability determining unit 32 determines that the situation around the vehicle 10 is a detection-enabled situation. More specifically, when there is no blind area ahead of the vehicle 10 or, if any, when a whole vehicle is never included in the blind area, the detectability determining unit 32 determines that the situation around the vehicle 10 is a detection-enabled situation.

The detectability determining unit 32 notifies the result of determination of the situation around the vehicle 10 to the congestion-relief determining unit 33.

The congestion-relief determining unit 33 determines whether congestion is relieved around the vehicle 10, based on motion of a vehicle traveling in an area around the vehicle 10 and detected from an image obtained by the camera 3, at predetermined intervals after a notification that the situation around the vehicle 10 is a detection-enabled situation.

For example, to determine whether congestion caused by a structure of the road is relieved, the congestion-relief determining unit 33 determines whether there is a location likely to cause congestion (e.g., a merge or split location) beyond or behind the current position of the vehicle 10. For example, the congestion-relief determining unit 33 refers to the current position of the vehicle 10 and the high-precision map to determine whether there is a location where the road being traveled by the vehicle 10 splits (hereafter, a “split point”) within a first section beyond and behind the current position of the vehicle 10 (e.g. 1 km ahead and behind) or a location where the road merges (hereafter, a “merge point”) within a second section behind the current position of the vehicle 10 (e.g., 1 km).

When there is a split point in the first section or a merge point in the second section, the congestion-relief determining unit 33 calculates an average speed or an average acceleration of one or more vehicles around the vehicle 10. The congestion-relief determining unit 33 can calculate the speeds of the respective vehicles relative to the vehicle 10 at the time of acquisition of each image by executing a process similar to that executed by the congestion determining unit 31, i.e., by inputting time-series images obtained from the camera 3 into a classifier to detect one or more vehicles and track the detected individual vehicles. Then, the congestion-relief determining unit 33 can calculate the average of the speeds (i.e., the average speed) or that of the accelerations (i.e., the average acceleration) of the vehicles, based on the speed of the vehicle 10 and the relative speeds of the other vehicles at the time of acquisition of each image. The congestion-relief determining unit 33 determines that congestion is relieved, when the average speed of the vehicles is not less than a predetermined speed threshold or when the average acceleration of the vehicles around the vehicle 10 is not less than a predetermined acceleration threshold. The predetermined speed may be, for example, a speed obtained by subtracting a predetermined offset (e.g., 5 km/h to 10 km/h) from the legally permitted speed or the regulation speed of the road being traveled by the vehicle 10. The congestion-relief determining unit 33 can identify the legally permitted speed or the regulation speed of the road being traveled by the vehicle 10 by referring to the current position of the vehicle 10 and the high-precision map. In this way, the congestion-relief determining unit 33 can correctly determine whether congestion caused by a structure of the road being traveled by the vehicle 10 is relieved, based on the presence or absence of a location likely to cause congestion and on motion of another vehicle.

Additionally, to determine whether congestion caused by a predetermined event is relieved, the congestion-relief determining unit 33 determines whether the predetermined event has occurred beyond or behind the current position of the vehicle 10. The predetermined event refers to an event causing at least part of the road being traveled by the vehicle 10 to be obstructed, and includes, for example, the execution of road construction, the occurrence of an accident, and the presence of a vehicle parked on the road or a fallen object. In such a case, the congestion-relief determining unit 33 inputs, for example, the latest image obtained from the camera 3 into a classifier to determine whether an object, such as a signboard, for making a notification of road construction or occurrence of an accident. As such a classifier, it uses, for example, a DNN having a CNN architecture like the classifier described in relation to the congestion determining unit 31. When an object for making a notification of road construction or occurrence of an accident is detected in the inputted image by the classifier, the congestion-relief determining unit 33 determines that road construction is carried out or an accident has occurred. Similarly, when a fallen object on the road is detected in the inputted image by the classifier in response to input of the latest image obtained from the camera 3 into the classifier, the congestion-relief determining unit 33 may determine that there is a fallen object on the road. Alternatively, as described in relation to the congestion determining unit 31, the congestion-relief determining unit 33 may input time-series images obtained from the camera 3 into a classifier to detect vehicles around the vehicle 10, and track the detected vehicles, thereby detecting a vehicle standing still on the road during tracking, i.e., a vehicle parked on the road.

Upon detection of the occurrence of a predetermined event, the congestion-relief determining unit 33 calculates an average acceleration of other vehicles around the vehicle 10. The congestion-relief determining unit 33 can calculate the average acceleration of the vehicles by executing detection and tracking of the vehicles, as described above. When the average acceleration of the vehicles around the vehicle 10 is not less than the predetermined acceleration threshold, the congestion-relief determining unit 33 determines that congestion is relieved. In this way, based on the presence or absence of a predetermined event, which causes at least part of the road to be obstructed and may cause congestion, and on motion of another vehicle, the congestion-relief determining unit 33 can correctly determine whether congestion caused by the predetermined event that has occurred on the road being traveled by the vehicle 10 is relieved.

Additionally, when congestion around the vehicle 10 is “natural congestion,” the congestion-relief determining unit 33 calculates an average speed of one or more vehicles around the vehicle 10 in a preceding predetermined period in order to determine whether the natural congestion is relieved. The congestion-relief determining unit 33 can calculate an average speed of one or more vehicles around the vehicle 10 in a preceding predetermined period by executing detection and tracking of the vehicles, as described above.

For example, when any of the following conditions (i) to (iii) is satisfied, the congestion-relief determining unit 33 determines that congestion is relieved:
(i) the average speed of the vehicles around the vehicle 10 is kept greater than the speed obtained by subtracting a first offset (e.g., 15 km/h) from the legally permitted speed or the regulation speed of the road being traveled by the vehicle 10 for a first period (e.g., 10 seconds),
(ii) the average speed of the vehicles around the vehicle 10 is kept greater than the speed obtained by subtracting a second offset (e.g., 10 km/h), which is smaller than the first offset, from the legally permitted speed or the regulation speed of the road being traveled by the vehicle 10 for a second period (e.g., 5 seconds) shorter than the first period, and
(iii) the average speed of the vehicles around the vehicle 10 is kept greater than the speed obtained by subtracting a third offset (e.g., 5 km/h), which is smaller than the second offset, from the legally permitted speed or the regulation speed of the road being traveled by the vehicle 10 for a third period (e.g., 1 second) shorter than the second period.

In this way, the congestion-relief determining unit 33 can correctly determine whether natural congestion is relieved, based on the average speed of the vehicles around the vehicle 10 and the period during which the average speed is maintained.

When it is determined that congestion is relieved, the congestion-relief determining unit 33 notifies the result of determination to the vehicle control unit 34.

When notified of occurrence of congestion around the vehicle 10 by the congestion determining unit 31, the vehicle control unit 34 switches the driving mode applied to the vehicle 10 from manual driving mode to automated driving mode. At the switch, the vehicle control unit 34 may cause the user interface 6 to display a message indicating switching the driving mode applied to the vehicle 10 from manual driving mode to automated driving mode or to output a voice of the message, thereby notifying the driver of switching the driving mode. After the notification, the vehicle control unit 34 controls the vehicle 10 so as to automatically drive it.

When notified of relief of congestion around the vehicle 10 by the congestion-relief determining unit 33, the vehicle control unit 34 conversely switches the driving mode applied to the vehicle 10 from automated driving mode to manual driving mode. At the switch, the vehicle control unit 34 causes the user interface 6 to display a message indicating switching the driving mode applied to the vehicle 10 from automated driving mode to manual driving mode or to output a voice of the message, thereby notifying the driver of switching the driving mode. After the elapse of a predetermined period from the notification, the vehicle control unit 34 stops automated driving of the vehicle 10 and thereafter controls travel of the vehicle 10 according to a driver operation. The vehicle control unit 34 may continue automated driving of the vehicle 10 until receiving a signal indicating that the steering wheel is held from a touch sensor (not illustrated) provided on the steering wheel.

While automated driving mode is applied to the vehicle 10, the vehicle control unit 34 generates one or more planned trajectories of the vehicle 10 in the nearest predetermined section (e.g., 500 m to 1 km) so that the vehicle 10 will travel along a planned travel route to a destination. Each planned trajectory is represented, for example, as a set of target positions of the vehicle 10 at respective time points during travel of the vehicle 10 through the predetermined section. The vehicle control unit 34 controls components of the vehicle 10 so that the vehicle 10 will travel along the planned trajectory.

The vehicle control unit 34 generates a planned trajectory so that the vehicle 10 will not collide with objects around the vehicle 10 (e.g., other vehicles) detected from time-series images obtained by the camera 3. For example, the vehicle control unit 34 inputs time-series images obtained by the camera 3 into a classifier to detect objects and tracks the detected objects, as described in relation to the congestion determining unit 31. When the congestion-relief determining unit 33 has detected objects and is tracking them, the vehicle control unit 34 may use the result of tracking by the congestion-relief determining unit 33. The vehicle control unit 34 predicts trajectories of the respective objects to a predetermined time ahead from the trajectories obtained from the result of tracking. To this end, the vehicle control unit 34 can estimate the positions of the detected objects at the time of acquisition of each image, using the current position and orientation of the vehicle 10, estimated distances to the detected objects, and the directions from the vehicle 10 to the objects at the time of acquisition of each image. The position and orientation of the vehicle 10 at the time of acquisition of each image may be estimated by comparing the image obtained by the camera 3 with the high-precision map, as described in relation to the congestion determining unit 31. The vehicle control unit 34 can predict trajectories of the detected objects, using, for example, a Kalman filter or a particle filter to execute a tracking process on the estimated positions of the objects at the time of acquisition of each image.

The vehicle control unit 34 generates a planned trajectory of the vehicle 10, based on the predicted trajectories of the tracked objects, so that a predicted distance between the vehicle 10 and any of the objects will be not less than a predetermined distance until a predetermined time ahead. The vehicle control unit 34 may generate multiple planned trajectories. In this case, the vehicle control unit 34 may select one of the planned trajectories such that the sum of the absolute values of acceleration of the vehicle 10 will be the smallest.

Upon setting a planned trajectory, the vehicle control unit 34 controls components of the vehicle 10 so that the vehicle 10 will travel along the planned trajectory. For example, the vehicle control unit 34 determines a target acceleration of the vehicle 10 according to the planned trajectory and the current speed of the vehicle 10 measured by the vehicle speed sensor (not illustrated), and sets the degree of accelerator opening or the amount of braking so that the acceleration of the vehicle 10 will be equal to the target acceleration. The vehicle control unit 34 then determines the amount of fuel injection according to the set degree of accelerator opening, and outputs a control signal depending on the amount of fuel injection to a fuel injector of the engine of the vehicle 10. Alternatively, the vehicle control unit 34 outputs a control signal depending on the set amount of braking to the brake of the vehicle 10.

When changing the direction of the vehicle 10 in order for the vehicle 10 to travel along the planned trajectory, the vehicle control unit 34 determines the steering angle of the vehicle 10 according to the planned trajectory and outputs a control signal depending on the steering angle to an actuator (not illustrated) that controls the steering wheel of the vehicle 10.

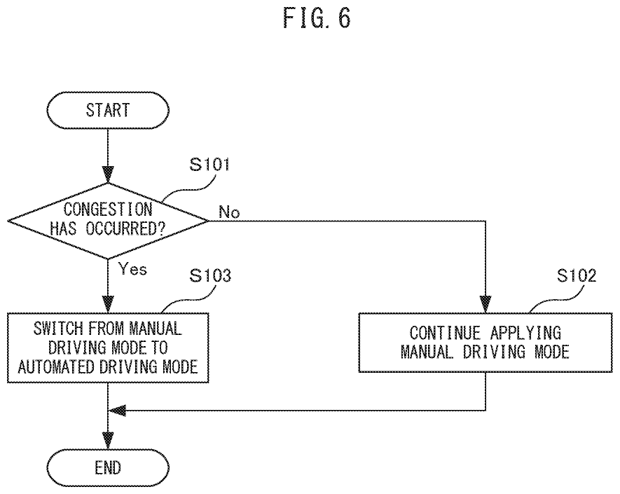

FIG. 6 is an operation flowchart of the vehicle control process executed by the processor 23 and related to switching from manual driving mode to automated driving mode. While manual driving mode is applied to the vehicle 10, the processor 23 may execute the vehicle control process related to switching from manual driving mode to automated driving mode in accordance with the following operation flowchart at predetermined intervals.

The congestion determining unit 31 of the processor 23 determines whether congestion has occurred around the vehicle 10, based on motion of the vehicle 10, motion of another vehicle in an area around the vehicle 10, or received traffic information (step S101). In the case that congestion has not occurred around the vehicle 10 (No in Step S101), the vehicle control unit 34 of the processor 23 continues applying manual driving mode (step S102). In the case that congestion has occurred around the vehicle 10 (Yes in Step S101), the vehicle control unit 34 switches the applied driving mode from manual driving mode to automated driving mode (step S103). After the switch, the vehicle control unit 34 controls the vehicle 10 so as to automatically drive it. After step S102 or S103, the processor 23 terminates the vehicle control process related to switching from manual driving mode to automated driving mode.

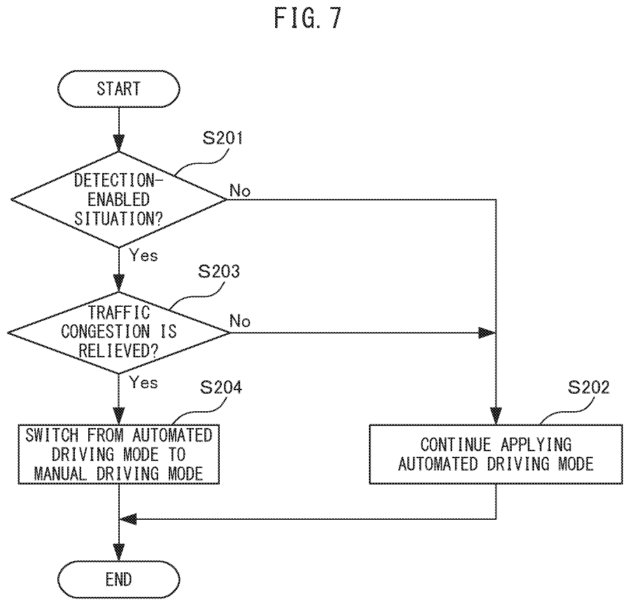

FIG. 7 is an operation flowchart of the vehicle control process executed by the processor 23 and related to switching from automated driving mode to manual driving mode. While automated driving mode is applied to the vehicle 10, the processor 23 may execute the vehicle control process related to switching from automated driving mode to manual driving mode in accordance with the following operation flowchart at predetermined intervals.

The detectability determining unit 32 of the processor 23 determines whether the situation around the vehicle 10 is a detection-enabled situation, based on the current position of the vehicle 10, the high-precision map, or an image obtained by the camera 3 (step S201). When the situation around the vehicle 10 is a detection-disabled situation (No in Step S201), the congestion-relief determining unit 33 of the processor 23 does not determine whether congestion is relieved and the vehicle control unit 34 of the processor 23 continues applying automated driving mode (step S202).

When the situation around the vehicle 10 is a detection-enabled situation (Yes in Step S201), the congestion-relief determining unit 33 determines whether congestion is relieved around the vehicle 10, based on the current position of the vehicle 10, the high-precision map, or an image obtained by the camera 3 (step S203). When congestion is not relieved around the vehicle 10 (No in Step S203), the vehicle control unit 34 continues applying automated driving mode (step S202).

When congestion is relieved around the vehicle 10 (Yes in Step S203), the vehicle control unit 34 switches the applied driving mode from automated driving mode to manual driving mode (step S204). After the switch, the vehicle control unit 34 stops automated driving of the vehicle 10. After step S202 or S204, the processor 23 terminates the vehicle control process related to switching from automated driving mode to manual driving mode.

As has been described above, the vehicle controller controls a vehicle so as to automatically drive the vehicle while traffic is congested around the vehicle. Upon relief of congestion around the vehicle, the vehicle controller switches the driving mode applied to the vehicle from automated driving mode to manual driving mode. To prevent erroneous determination that congestion is relieved, the vehicle controller determines whether the situation around the vehicle is a detection-enabled situation. The vehicle controller determines whether congestion is relieved, only when the situation is a detection-enabled situation. In this way, the vehicle controller does not determine whether congestion is relieved around the vehicle in a situation that motion of another vehicle in an area around the vehicle cannot be correctly detected, and thus can prevent erroneous determination that congestion is relieved. This enables the vehicle controller to inhibit frequent switching between the state of determination that traffic is congested and the state of determination that congestion is relieved and frequent occurrence of handover of control between automated driving control and manual driving control. As a result, the vehicle controller can prevent frequent request for handover of vehicle operation to the driver, allowing for lightening the driver's load.

According to a modified example, the detectability determining unit 32 may change a criterion of determination whether it is a detection-enabled situation, depending on environment around the vehicle 10. For example, when an object ahead of the vehicle 10 other than the shielding objects described in the embodiment covers at least part of the detection area of the camera 3 or the distance sensor mounted on the vehicle 10, the detectability determining unit 32 may determine that it is a detection-disabled situation. Examples of such an object include a pillar of a tunnel, a signboard indicating a section under construction, a stopped vehicle, and a tollgate. The detectability determining unit 32 may determine whether there is such an object within a predetermined distance ahead of the vehicle 10 by referring to the current position of the vehicle 10 and the high-precision map, and determine that it is a detection-disabled situation, when there is such an object. As described above, the current position of the vehicle 10 may be the position indicated by the latest positioning information from the GPS receiver 2 or the position estimated by comparing an image obtained by the camera 3 with the high-precision map, as described in relation to the congestion determining unit 31. Alternatively, the detectability determining unit 32 may determine that it is a detection-disabled situation, when such an object is detected by inputting an image obtained from the camera 3 into a classifier. As the classifier, the detectability determining unit 32 may use a DNN having a CNN architecture that has been trained to detect such an object, as described in relation to the congestion determining unit 31 in the embodiment.

The detectability determining unit 32 may determine that it is a detection-disabled situation, when visibility is temporarily lowered by, for example, backlight or smoke from a smoke pot. For example, when the condition for capturing by the camera 3 is a backlight condition, the luminance of an area in an image obtained by the camera 3 (e.g., an area representing the sun) will be extremely high. When smoke from a smoke pot is represented in an image, the luminance of the smoke area will be substantially uniform. Thus, for example, the detectability determining unit 32 divides an image obtained by the camera 3 into subareas (e.g., two-by-two or three-by-three subareas), and calculates the average or variance of luminance for each subarea. Then, the detectability determining unit 32 may determine that it is a detection-disabled situation, when the average of luminance is not less than a predetermined luminance threshold (e.g., a value obtained by multiplying the maximum possible luminance by 0.95) or the variance of luminance is not greater than a predetermined variance threshold for one or more subareas.

Additionally, a vehicle traveling ahead of the vehicle 10 may fall outside the detection area of the camera 3 or the distance sensor, depending on the curvature of the road ahead of the vehicle 10 (e.g., at a curved location or an intersection where it turns left or right when traveling along a planned travel route). Thus, the detectability determining unit 32 may determine that it is a detection-disabled situation, when the curvature of the road ahead of the vehicle 10 is not less than a predetermined curvature threshold. The detectability determining unit 32 can determine the curvature of the road ahead of the vehicle 10 by referring to the current position of the vehicle 10 and the high-precision map or detecting, for example, a lane dividing line from an image obtained by the camera 3, as described in the embodiment.

According to another modified example, the vehicle control unit 34 may decrease the level of automated driving control applied to the vehicle 10 for the case that congestion is relieved around the vehicle 10 as compared to the level thereof for the case that traffic is congested around the vehicle 10. For example, when congestion is relieved around the vehicle 10, the vehicle control unit 34 may continue automated driving control of the vehicle 10 on condition that the driver is looking ahead of the vehicle 10. In this case, the vehicle control unit 34 may detect the looking direction of the driver from an in-vehicle image obtained, for example, from a driver monitoring camera (not illustrated) provided in the interior of the vehicle 10 so as to take pictures of the driver's head, thereby determining whether the driver is looking ahead of the vehicle 10. For this purpose, the vehicle control unit 34 may detect, for example, the driver's pupil and a corneal reflection image of a light source for illuminating the driver (Purkinje image) from an in-vehicle image, and detect the looking direction of the driver, based on the positional relationship between the centroid of the pupil and the Purkinje image.

Alternatively, when congestion is relieved around the vehicle 10, the vehicle control unit 34 may automatically control the speed of the vehicle 10 so as to keep the distance between the vehicle 10 and a vehicle traveling ahead of the vehicle 10 constant. However, in this case, the vehicle control unit 34 controls the travel direction of the vehicle 10 according to the driver operation of the steering wheel.

A computer program for achieving the functions of the processor 23 of the ECU 7 according to the embodiment or modified examples may be provided in a form recorded on a computer-readable and portable medium, such as a semiconductor memory, a magnetic recording medium, or an optical recording medium.

As described above, those skilled in the art may make various modifications according to embodiments within the scope of the present invention.

What is claimed is:

1. A vehicle controller for automated driving control of a vehicle in traffic congestion, comprising:
a processor configured to
determine whether the situation around the vehicle is a detection-enabled situation in which another vehicle traveling on a road within a predetermined distance of the vehicle in a travel direction of the vehicle is detectable by a sensor for detecting the situation around the vehicle, the sensor being mounted on the vehicle, and
determine whether congestion is relieved around the vehicle, based on motion of the other vehicle detected based on a sensor signal obtained by the sensor, when the situation around the vehicle is the detection-enabled situation.

2. The vehicle controller according to claim 1, wherein the processor is further configured to determine whether there is a blind area where the other vehicle is undetectable within the predetermined distance, based on map information stored in a memory or an image obtained by the sensor taking a picture in the travel direction of the vehicle, and the processor determines that the situation is not a detection-enabled situation, when the blind area exists.

3. The vehicle controller according to claim 2, wherein the processor determines that the blind area exists, when it is detected that the road in the travel direction of the vehicle has a curve within the predetermined distance and that there is a shielding object inside the curve of the road, based on the map information and the current position of the vehicle or on the image, and the curvature of the curve of the road is not less than a predetermined threshold.

4. The vehicle controller according to claim 2, wherein the processor determines that the blind area exists, when it is detected that the current position of the vehicle is on an upward slope and that the top of the upward slope is within the predetermined distance, based on the map information and the current position of the vehicle.

5. A method for automated driving control of a vehicle in traffic congestion, comprising:
determining whether the situation around the vehicle is a detection-enabled situation in which another vehicle traveling on a road within a predetermined distance of the vehicle in a travel direction of the vehicle is detectable by a sensor for detecting the situation around the vehicle, the sensor being mounted on the vehicle; and
determining whether congestion is relieved around the vehicle, based on motion of the other vehicle detected based on a sensor signal obtained by the sensor, when the situation around the vehicle is the detection-enabled situation.
